(19) United States
(12) Patent Application Publication
(10) Pub. No.: US 2021/0131908 A1
(43) Pub. Date: May 6, 2021

(54) Monitoring device for a vacuum-insulated system

(71) Applicant: NEXANS, Courbevoie (FR)

(72) Inventors: Jurgen ESSLER, REHBURG-LOCCUM (DE); Frank SCHMIDT, Langenhagen (DE)

(21) Appl. No.: 17/067,613

(22) Filed: Oct. 9, 2020

(30) Foreign Application Priority Data
Oct. 10, 2019 (EP) 19 306 326.0

(51) Int. Cl. G01M 3/36; G01M 3/28

(52) U.S. Cl. CPC G01M 3/36; G01M 3/2815

(57) ABSTRACT

A monitoring device (118) for monitoring the leak-tightness of a vacuum-insulated system has a corrugated bellows (108) which is connected in terms of flow to an evacuated space (104) of the vacuum-insulated system in such a way that, in the event of an increase in pressure in the evacuated space, the length of the corrugated bellows (108) is adjusted beyond a threshold value. A position detector (113) connected to an energy store (115) responds to the change in length of the corrugated bellows and outputs a signal. The position detector outputs a signal to a display device (116), which provides an indication if a leak in the vacuum-insulated system occurs.

### RELATED APPLICATION

This application claims the benefit of priority from European Patent Application No. 19 306 326.0, filed on Oct. 10, 2019, the entirety of which is incorporated by reference.

### FIELD OF THE INVENTION

The invention relates to a monitoring device for monitoring the leak-tightness of a vacuum-insulated system. The monitoring system is, for example, configured to monitor the vacuum of a vacuum-insulated transfer line or of a superconductive cable system. The invention also relates to a tubular coupling for connecting two vacuum-insulated systems, which may for example be a section of a transfer line or of a superconductive cable. The invention also relates to a vacuum-insulated system having a monitoring device, and/or having a tubular coupling, according to the invention. Finally, the invention also relates to a method for retrofitting a vacuum-insulated system with a monitoring device.

### BACKGROUND

A vacuum-insulated system involves for example a pipe or a pipeline for conducting a cooled medium, for example a cryogenic liquefied gas, around which pipe or pipeline a vacuum insulation which is closed off outwardly by a metallic pipe and which is subjected to operation in a vacuum is present. Another frequent application for a vacuum-insulated system is a cryostat for a superconductive cable. The vacuum-insulated system normally has an outer pipe and an inner pipe, which are separated by an evacuated space that provides for the thermal insulation of an inner pipe. The evacuated space of a vacuum-insulated system is normally closed off in a hermetically sealed manner by a metallic wall. The evacuated space or “vacuum space” may in principle be any hermetically sealed space in which the intention is to maintain a vacuum of greater or lesser strength. The further embodiments, representing all the other possible uses, relate to such a vacuum insulation.

In order to identify a leakage—referred to below for short as “leak”—in the sealed “casing” of a vacuum space, a response threshold of several kPa is sufficient. Pressures in the region of 10⁻³ Pa are normal for a vacuum insulation. The vacuum insulation largely loses its effectiveness in the region of 0.1 Pa. In the event of the occurrence of a leak in the outer pipe delimiting the vacuum insulation, a pressure of approximately 10⁵ Pa is attained after a short time, whereas in the event of a leak in the inner pipe, a pressure, corresponding to the operating pressure, of for example up to 2 MPa can occur after a short time.

For the purpose of monitoring the vacuum, it is proposed in EP 1 953 517 A1 to connect a metallic corrugated bellows to the vacuum space in a hermetically sealed manner. If a leak occurs in the vacuum space, then the corrugated bellows extends and actuates a proximity switch which generates a signal which indicates a leak.

The corrugated bellows of the known monitoring device is welded onto the outer pipe of the vacuum-insulated system. The proximity switch is connected to a power supply, which provides the electrical energy required for the operation.

Taking this as a starting point, the object of the present invention is to provide a monitoring device for monitoring the leak-tightness of a vacuum-insulated system that is easier to attach and/or that increases the operational reliability of the vacuum-insulated system.

### SUMMARY OF THE INVENTION

To achieve said object, the invention proposes, according to a first aspect, a monitoring device for monitoring the leak-tightness of a vacuum-insulated system. The monitoring device has a corrugated bellows which is connected in terms of flow to an evacuated space of the vacuum-insulated system in such a way that, in the event of an increase in pressure in the evacuated space, the length of the corrugated bellows is adjusted beyond a threshold value. A position detector connected to an energy store responds to the change in length of the corrugated bellows and outputs a signal.

The monitoring device of the vacuum-insulated system is independent of the operational control unit for the system, which is generally present anyway. The monitoring system thus constitutes a redundant safeguarding system which functions independently of an operational control unit. The energy store, which may for example be a battery or a pressure store for a fluid, supplies energy to the position detector. The energy store also gives the monitoring device the characteristic of functioning independently of the public electricity supply. In this way, a high degree of operational reliability is advantageously achieved for the vacuum-insulated system.

According to one embodiment, the monitoring device is arranged on a cover which is able to be mounted onto a flange of the vacuum-insulated system. This embodiment of the monitoring device is able to be retrofitted easily in that, for example, a blind cover of the vacuum-insulated system is replaced by a cover having the monitoring device arranged thereon.

In an expedient refinement of the monitoring device, the position detector is connected to a display device, which receives the signal of the position detector and indicates a leak in the vacuum-insulated system.

The display device may be situated for example in a control station, so that operating personnel can react to the indication of a leak with countermeasures or protective measures, for example activate additional vacuum pumps.

Advantageously, in one exemplary embodiment, the position detector is connected to a safeguarding device, which receives the signal of the position detector and initiates a measure for safeguarding the vacuum-insulated system. The advantage of this exemplary embodiment is that, even without the active intervention of operating personnel, protective measures can be initiated, automatically.

The position detector advantageously outputs the signal to the display device if the increase in pressure exceeds a first threshold value, and outputs a further signal to the safeguarding device if the increase in pressure exceeds a second threshold value.

In this embodiment, operating personnel can keep a small leak under control, for example by activating one or more additional vacuum pumps. Protective measures are initiated automatically, for example in that a pressure-relief valve is opened, only if the increase in pressure exceeds a second threshold value.

According to a second aspect of the invention, a tubular coupling having a monitoring device according to the first aspect of the invention which is arranged in an outer wall of the tubular coupling is proposed. The tubular coupling has the advantage that, with this, it is possible for vacuum-insulated systems to be retrofitted in a simple manner with the monitoring device.

According to a third aspect of the invention, a vacuum-insulated system having a monitoring device according to the first aspect and/or having a tubular coupling according to the second aspect of the invention is proposed.

Finally, according to a fourth aspect of the invention, a method for retrofitting a superconductive cable system with a monitoring device for monitoring the leak-tightness of a vacuum-insulated system is proposed. The method comprises
replacing a blind cover on the vacuum-insulated system by a cover on which the monitoring device is installed
or
dismounting an auxiliary unit of the vacuum-insulated system;
mounting a tubular coupling according to the second aspect of the invention; and
mounting the previously dismounted auxiliary unit.

### BRIEF DESCRIPTION OF THE DRAWING

The invention will be discussed in more detail below by way of example on the basis of exemplary embodiments and with reference to the accompanying figures. All the figures are purely schematic and not to scale. In the figures:

FIG. 1 shows a schematic illustration of a vacuum-insulated pipeline with a monitoring device;

FIG. 2 shows a superconductive cable system with cooling installation and vacuum pump;

FIG. 3 shows a further embodiment of a monitoring device according to the invention;

FIG. 4 shows a tubular coupling with a monitoring device according to the invention;

FIG. 5A shows a flow diagram for a first working method for retrofitting a vacuum-insulated system; and

FIG. 5B shows a flow diagram for a second working method for retrofitting a vacuum-insulated system.

Identical or similar elements are provided with identical or similar reference signs in the figures.

### DETAILED DESCRIPTION

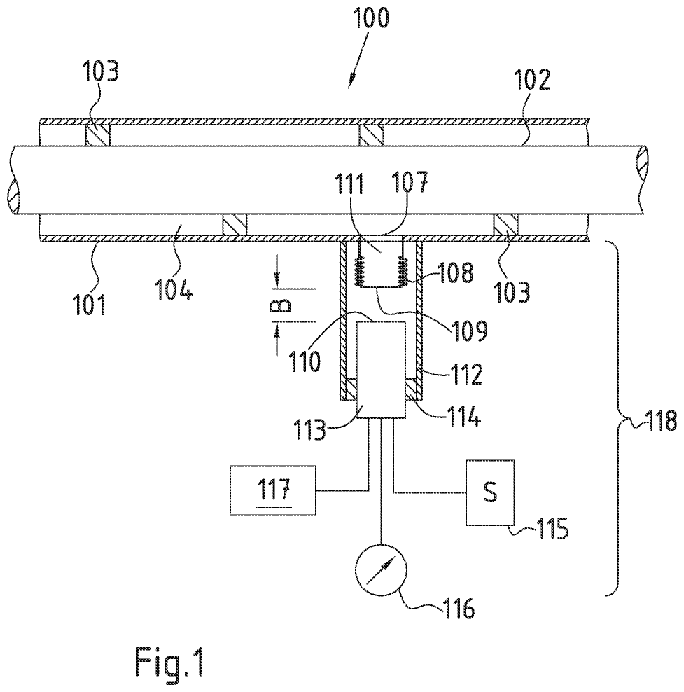

FIG. 1 illustrates purely schematically a vacuum-insulated pipeline 100. The vacuum-insulated pipeline 100 may be a transfer line, such as is used for example for the transport of liquefied natural gas or other cryogenic media. The pipeline 100 may also be a cable cryostat of a superconductive cable. The pipeline 100 comprises an outer pipe 101 and an inner pipe 102, which are held in position relative to one another by spacers 103. The spacers 103 have the effect in particular that the inner pipe and the outer pipe do not make contact, in order than no undesired heat transfer between the inner pipe 102 and the outer pipe 101 occurs. Situated between the outer pipe 101 and the inner pipe 102 is an evacuated space 104 or vacuum space, which thermally insulates the inner pipe, in which a cryogenic medium flows, with respect to the outer pipe. If the vacuum-insulated system is part of a superconductive cable system, cooling liquid, for example liquid nitrogen (LN2), flows in the inner pipe and cools the superconductor to below its critical temperature.

The outer pipe 101 has an opening 107. The opening 107 is closed off in a hermetically sealed manner by a metallic corrugated bellows 108. A first end of the corrugated bellows 108 is closed off in a vacuum-tight manner by a closure 109, while a second end of the corrugated bellows 108 is open and is welded on over the opening 107 of the outer pipe 101. In principle, other types of connection are also possible. It is only necessary that the connections are vacuum-tight. An inner space 111 of the corrugated bellows 108 is thus connected in terms of flow to the evacuated space 104. The corrugated bellows 108 consists of metal, for example of high-grade steel with a wall thickness of for example 0.1 mm to 0.4 mm. However, other materials, for example copper or a fibre-reinforced plastic, may also be considered for the corrugated bellows 108. Arranged around the corrugated bellows 108 is a protective pipe 112, which, for example, is welded on the outer pipe 101 and surrounds the corrugated bellows 108 with a radial spacing. A proximity switch 113 is arranged on that end of the protective pipe 112 opposite the corrugated bellows 108 and is sealed off with respect to an inner side of the protective pipe 112 by a sealing element 114. The corrugated bellows 108 and the proximity switch 113 are surrounded in a substantially sealed manner by the protective pipe 112 and, in this way, effectively protected from environmental influences. Nevertheless, approximately atmospheric pressure prevails in the inside space of the protective pipe 112.

The length of the protective pipe 112 is dimensioned such that the corrugated bellows 108, in the relaxed state, approaches the proximity switch 113 but does not make contact with it. The relaxed state of the corrugated bellows 108 is established if atmospheric pressure prevails in the normally evacuated space 104. In FIG. 1, the vacuum space 104 is evacuated and the corrugated bellows 108 is compressed in a longitudinal direction by way of the difference in pressure between the inside space of the corrugated bellows 108 and the outside space thereof.

If, in the event of an operational fault of the vacuum-insulated pipeline 100, a positive pressure is formed in the evacuated space 104, then the closure 109 of the corrugated bellows 108 comes into contact with an end side 110 of the proximity switch 113 and supports the corrugated bellows 108. This prevents the corrugated bellows 108 from being damaged in a positive pressure situation. The monitoring system 101 formed in this manner is an extremely robust system.

The proximity switch 113 is connected to an energy store 115. The energy store 115 is an electric battery in one exemplary embodiment. Furthermore, the proximity switch may also be connected to an electrical supply network. The proximity switch 113 is, in signal terms, also connected to an evaluation and display device 116 and to a safeguarding device 117. The safeguarding device 117 is for example a relief valve or the like. The proximity switch is preferably of a two-stage design, that is to say, in the event of increasing pressure in the evacuated space, upon exceedance of a first threshold value, firstly only a signal is output to the display device 116, and, if the pressure continues to increase and exceeds a second threshold value, then a signal is also output to the safeguarding device 117, with the result that the safeguarding device 117 responds.

The components welded onto the outer pipe 101 form, in cooperation with the proximity switch 113, a monitoring device, denoted overall by the reference sign 118, which monitors the vacuum in the evacuated space 104 of the pipeline 100.

In other exemplary embodiments (not illustrated), the monitoring device 118 comprises no energy store 115 and/or no safeguarding device 117.

If existing pipelines 100 are intended to be retrofitted with a monitoring device 118 described in FIG. 1, this requires complex welding tasks which, for practical reasons, are not always able to be carried out.

Using the example of a superconductive cable system, the intention is to describe an alternative embodiment of the monitoring device that is able to be retrofitted without welding tasks.

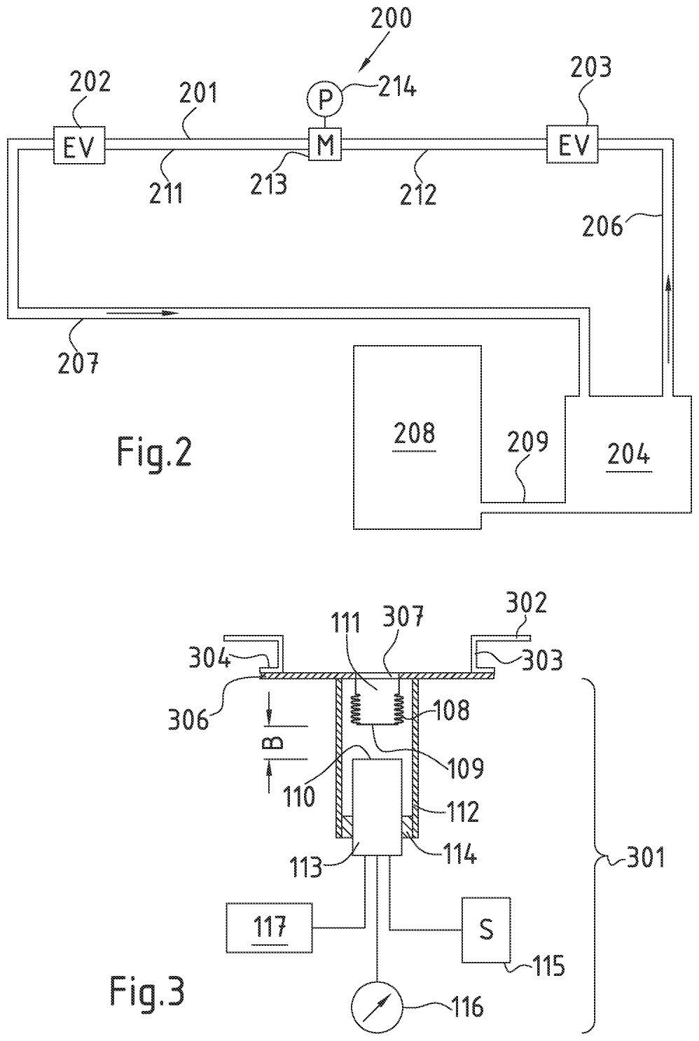

For the purpose of explanation, FIG. 2 illustrates, first of all, a superconductive cable system 200 having a superconductive cable 201. The superconductive cable 201 is for example a coaxial cable having three superconductors, as is described for example in the German utility model DE 20 2019 003 381. The superconductive cable 201 is provided at its ends with terminations 202, 203. A cooling installation 204 is connected to the termination 203 via a supply line 206 for coolant. The termination 202 is connected to the cooling installation 204 via a return line 207 for coolant. A coolant storage tank 208, which is advantageously designed as a cryotank, is connected to the cooling installation 204 via a feed line 209. The supply line 206, the return line 207 and the feed line 209 are preferably designed as cryogenic lines, that is to say as is double-walled vacuum-insulated lines.

The superconductive cable 201 is constructed in a two-part manner from a first superconductive cable 211 and a second superconductive cable 212, which are connected to one another by a connecting tubular coupling 213. The connecting tubular coupling 213 establishes a superconductive connection between the individual superconductors in the cables 211 and 212.

A vacuum pump 214 is moreover connected to the connecting tubular coupling, in order to maintain the vacuum in the evacuated space of the superconductive cable 201. Moreover, a monitoring device 301, illustrated in FIG. 3, for monitoring the vacuum in the evacuated space, is arranged on the connecting tubular coupling 213. In the present case, the evacuated space involves the insulation vacuum of the superconductive cable 201.

FIG. 3 schematically shows a greatly enlarged detail from an outer wall 302 of the connecting tubular coupling 213 where the monitoring device 301 is arranged. The insulation vacuum of the superconductive cable 201 prevails within the outer wall 302 of the connecting tubular coupling 213. The outer wall 302 has a connection pipe 303 which is provided at one end with a flange 304. The connection pipe 303 is in particular an unused connection to the connecting tubular coupling 213 or to another point in the cable system 200. A cover 306 is mounted in a vacuum-tight manner onto the flange 304 and bears the monitoring device 301.

The lid 306 has an opening 307. The opening 307 is closed off in a hermetically sealed manner by a corrugated bellows 108 and establishes a connection in terms of flow to the insulating vacuum. Furthermore, the monitoring device 301 is constructed in the same way as the monitoring device 118.

That embodiment of the monitoring device 301 which is described in FIG. 3 is also suitable for vacuum-insulated pipelines 100 which transport cryogenic fluids.

The monitoring devices 118 and 301 function in the same manner, which is described as follows:

During operation, the pipeline 100 or the superconductive cable system 300, including the inside space 111 of the corrugated bellows 108, is in an evacuated state. Below, for the sake of brevity, reference is made to a vacuum-insulated system, which may be both a pipeline 100 and a superconductive cable system 300. The difference in pressure between the inside space 111 and the space outside the corrugated bellows 108 leads to the corrugated bellow 108 being compressed in its longitudinal direction. The compressed state of the corrugated bellows 108 is illustrated in FIGS. 1 and 3. Here, a spacing B between the closure 109 and the end side 110 of the proximity switch 113 is established. The spacing B is large enough that the proximity switch 113 does not respond. If a leak in the vacuum-insulated system leads to the pressure in the evacuated space and in the inside space of the corrugated bellows 108 increasing, the corrugated bellows 108 extends and the closure 109 approaches the end side 110 of the proximity switch 113. As soon as a predefined first spacing, smaller than the spacing B, is undershot, the proximity switch 113 is triggered and outputs a signal to the evaluation and display device 116. The predefined first spacing corresponds to the first threshold value of the pressure. The display device 116 then indicates, for example on a control panel, that a leakage in the vacuum-insulated system has occurred. In this way, the operating personnel is given the opportunity to take countermeasures, for example to activate additional pumps or to throttle or completely interrupt the transport of cryogenic media or electric current through the vacuum-insulated system.

If the pressure continues to increase and exceeds a second threshold value, then the closure 109 approaches the proximity switch 113 up to a second spacing, which is smaller than the first spacing. The proximity switch 113 then also outputs a signal to the safeguarding device 117. The safeguarding device 117 is for example a relief valve which opens, when addressed by signals, so as to prevent, in the event of a leak of the inner pipe, formation of a positive pressure in the vacuum-insulated system due to evaporation of the cryogenic medium, which positive pressure could lead to damage. One particular advantage of the monitoring device is that it still functions even if a power failure in the general supply network is present, because the energy store 115 supplies it with the is energy required for the operation. In this way, increased operational reliability of the vacuum-insulated system is achieved.

In other exemplary embodiments, the proximity switch 113 is only of a single-stage design. In these exemplary embodiments, the response of the proximity switch 113 either initiates only a corresponding indication on the display device 116 or initiates the actuation of the safeguarding device 117. In a further exemplary embodiment, both actions are realized one after the other or at the same time.

In a modified exemplary embodiment, the energy store 115 is a pressure store which contains a pressurized fluid, such as for example compressed air, and the proximity switch 113 is designed as a fluid switch which is mechanically coupled to the corrugated bellows 108. The mechanical coupling is not illustrated in FIG. 3.

In principle, the monitoring device 118, 301, with a pressure switch, functions in the same way as in the above-described exemplary embodiments. If a first threshold value of the pressure in the evacuated space is attained, the proximity switch connects the pressure store 115 in terms of flow to the display device 116 on which the occurrence of a leak in the vacuum-insulated system is indicated. If the second threshold value is exceeded, then the proximity switch connects the pressure store 115 in terms of flow to the safeguarding device 117, so that for example a relief valve is hydraulically actuated. In another exemplary embodiment, the proximity switch is only of a single-stage design.

For existing vacuum-insulated systems, it may be the case that no unused connection pipe of the same type as the connection pipe 303 is available. In such cases, it is necessary to provide such a connection first of all, this being associated with complex welding tasks.

Alternatively, the present invention proposes to arrange the safeguarding device in an intermediate tubular coupling, which may for example be arranged at the place where a vacuum pump is installed in the vacuum-insulated system.

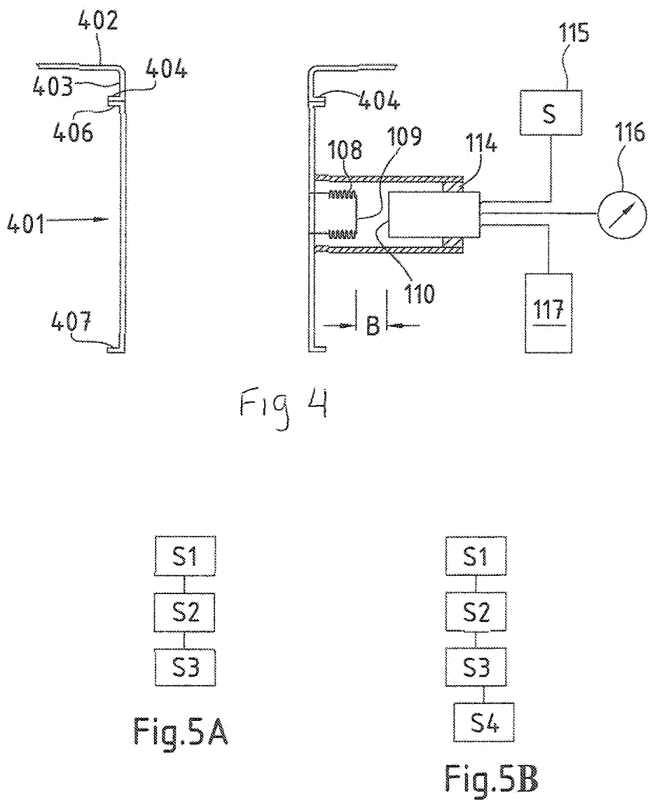

FIG. 4 shows an intermediate tubular coupling 401 in cross section. A connection pipe 403 with a flange 404 is arranged on an outer wall 402 of the vacuum-insulated system. In an initial situation, a vacuum pump (not illustrated) is installed on the connection pipe 403 or the flange 404. The vacuum pump is dismounted, and a flange 406 of the intermediate tubular coupling 401 is connected in a vacuum-tight manner to the flange 404. At an opposite end, the intermediate tubular coupling has a flange 407 which, for its part, provides a connection possibility again for the initially dismounted vacuum pump. The monitoring device 118 is mounted laterally on the outer wall of the intermediate tubular coupling and functions in the same manner as has been described in connection with the exemplary embodiments illustrated in FIGS. 1 and 3. The vacuum pump is mentioned here merely by way of example as an auxiliary unit of the vacuum-insulated system with which the flange 406 is connected in the initial situation.

FIG. 5A shows a schematic flow diagram for a first working method for retrofitting a vacuum-insulated system with a safeguarding device according to the invention. This method is able to be applied for systems in which an unused connection flange is available. In a first step S1, a blind cover is dismounted from an unused connection 303, and then, in a second step S2, a cover 306 having a monitoring device 301 is mounted. Subsequently, in a step S3, the electrical connections, or fluid lines, between the proximity switch 113, the energy store 115, the display device 116 and the safeguarding device 117 are set up. If required, an adaptor is arranged between the flange 304 and the cover 306, in order to bridge the different diameters of the flange 304 and the cover 306.

FIG. 5B shows a schematic flow diagram for a second working method for retrofitting a vacuum-insulated system for which no unused connection flange is available. In this method, the first step S1 is to firstly dismount an auxiliary unit, for example a vacuum pump, from a connection flange of the vacuum-insulated system. Then, in a second step S2, a tubular coupling 401 is mounted onto this flange, which has become free. In a step S3, the previously dismounted auxiliary unit is mounted onto the free end of the tubular coupling 401 by way of the flange 407. Subsequently, in a step S4, the electrical connections, or fluid lines, between the proximity switch 113, the energy store 115, the display device 116 and the safeguarding device 117 are set up. If required, in this application too, an adaptor is arranged between the flange 404 and the tubular coupling 401 or between the flange 407 and the auxiliary unit, in order to bridge different diameters.

List of reference signs

| | | | |
|---|---|---|---|
| 100 | Pipeline | 306 | Cover |
| 101 | Outer pipe | 307 | Opening |
| 102 | Inner pipe | 401 | Intermediate tubular coupling |
| 103 | Spacer | 402 | Outer wall |
| 104 | Evacuated space | 403 | Connection pipe |
| 201 | Hollow space | 404 | Flange |
| 107 | Opening | 406 | Flange |
| 108 | Corrugated bellows | 407 | Flange |
| 109 | Closure | | |
| 111 | Inside space of the | | |
| | corrugated bellows | | |
| 112 | Protective pipe | | |
| 113 | Proximity switch | | |
| 114 | Sealing element | | |
| 115 | Energy store | | |
| 116 | Display device | | |
| 117 | Safeguarding device | | |
| 118 | Monitoring device | | |
| 201 | Superconductive cable | | |
| 202, | Termination | | |
| 203 | | | |
| 204 | Cooling installation | | |
| 206 | Supply line | | |
| 207 | Return line | | |
| 208 | Coolant storage tank | | |
| 209 | Feed line | | |
| 211 | Superconductive cable | | |
| | section | | |
| 212 | Superconductive cable | | |
| | section | | |
| 213 | Connecting tubular | | |
| | coupling | | |
| 214 | Pump | | |
| 301 | Monitoring device | | |
| 302 | Outer wall | | |
| 303 | Connection pipe | | |
| 304 | Flange | | |

1. Monitoring device for monitoring the leak-tightness of a vacuum-insulated system comprising:
a corrugated bellows which is connected in terms of flow to an evacuated space of the vacuum-insulated system in such a way that, in the event of an increase in pressure in the evacuated space, the length of the corrugated bellows is adjusted beyond a threshold value,
whereupon a position detector connected to an energy store responds and outputs a signal.

2. Monitoring device according to claim 1, wherein the monitoring device is arranged on a cover which is able to be mounted onto a flange of the vacuum-insulated system.

3. Monitoring device according to claim 1, wherein the position detector is connected to a display device, which receives the signal of the position detector and indicates a leak in the vacuum-insulated system.

4. Monitoring device according to claim 1, wherein the position detector is connected to a safeguarding device, which receives the signal of the position detector and initiates a measure for safeguarding the vacuum-insulated system.

5. Monitoring device according to claim 4, wherein the position detector outputs the signal to the display device if the increase in pressure exceeds a first threshold value, and in that the position detector outputs a further signal to the safeguarding device if the increase in pressure exceeds a second threshold value.

6. Tubular coupling having a monitoring device according to claim 1, which is arranged in an outer wall of the tubular coupling.

7. Superconductive cable system having a monitoring device and a tubular coupling according to claim 6.

8. Method for retrofitting a vacuum-insulated system with a monitoring device for monitoring the leak-tightness of the vacuum-insulated system, wherein the method comprises
replacing a blind cover on the vacuum-insulated system by a cover on which the monitoring device is installed
or
dismounting an auxiliary unit of the vacuum-insulated system;
mounting a tubular coupling according to claim 6; and
mounting the previously dismounted auxiliary unit.
